(19) United States
(12) Patent Application Publication
(10) Pub. No.: US 2006/0280071 A1
(43) Pub. Date: Dec. 14, 2006

(54) Recorder, a disc and a method for recording information on a disc

(75) Inventors: Erwin Rinaldo Meinders, Eindhoven (NL); Gerardus Rudolph Langereis, Eindhoven (NL); Joachim Wilhelm Hellmig, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/567,838

(22) PCT Filed: Aug. 11, 2004
(86) PCT No.: PCT/IB04/51449

§ 371 Date: Feb. 8, 2006

(30) Foreign Application Priority Data
Aug. 12, 2003 (EP) 03102511.7

(51) Int. Cl. G11B 5/00

(52) U.S. Cl. 369/47.5

(57) ABSTRACT

When recording information in tracks or in a two-dimensional pattern care must be taken not to irradiate the adjacent tracks or pits. This results in a loss of data density on the recording medium because of the track pitch or pit distance that must be observed. A reduction in track pitch is possible to the point where the focused spot of the laser also irradiates the adjacent land area and tracks or pits. This increases the achievable data density of the recording medium. By using grooves and/or by using a dye with special absorption characteristics the effect of the irradiation of the adjacent tracks or pits can be reduced, effectively only recording marks in the desired location.

This invention relates to a method of recording information on an optical disc comprising a first groove, a second groove adjacent to the first groove and a land separating the first groove from the second groove by a track pitch distance Tp where the grooves are filled with a dye, where the land is covered by the dye, the method comprising irradiating a region of the optical disc with a focused spot of optical energy having a radius R₀ between a center of the focused spot and a point in the focused spot where the optical energy 1/e times a maximum optical energy of the focused spot, a recorder for recording optical discs comprising means for recording information on an optical disc comprising a first groove, a second groove adjacent to the first groove and a land separating the first groove from the second groove by a track pitch distance Tp where the grooves are filled with a dye, where the land is covered by the dye, the recorder comprising irradiation means for projecting a focused spot of optical energy having a radius R₀ between a center of the focused spot and a point in the focused spot where the optical energy 1/e times a maximum optical energy of the focused spot on the optical disc, and an optical disc comprising a first groove, a second groove adjacent to the first groove and a land separating the first groove from the second groove by a track pitch distance Tp where the grooves are filled with a dye, where the land is covered by the dye, for irradiation of the optical disc with a focused spot of optical energy having a radius R₀ between a center of the focused spot and a point in the focused spot where the optical energy 1/e times a maximum optical energy of the focused spot.

Such a method is known from optical recording where information on a disc is recorded using a focused spot with a radius R₀ of optical energy. At the radius R₀ the focused spot has a radiation intensity that is 1/e times the maximum radiation energy of the focused spot, typically reached at the center of the focused spot.

The spacing of the tracks or grooves or pits is such that a section of a single track or groove or a single pit falls inside the focused spot and is irradiated by the optical energy for recording while adjacent tracks or grooves or pits are at such a distance that they are not comprised in the focused spot within a radius R₀ from the center of the focused spot.

This puts a lower boundary on the spacing between the tracks or grooves or pits which is a disadvantage because it reduces the data density of the recording.

It is an objective of the invention to overcome this disadvantage and provide a method for recording information on a record carrier with an increased data density.

In order to achieve this objective the method is characterized in that the track pitch distance Tp is less or equal to the radius R₀ times five divided by three. The track pitch in this case is close to the radius R₀ of the focused spot which results in the writing region irradiated with a sufficient optical dose comprising the section of the track or groove to be writing and getting close to the adjacent tracks or grooves.

By reducing the track pitch more tracks fit on the record carrier allowing more data to be recorded on the same record carrier resulting in an increased data density.

A further embodiment of the method is characterized in that the track pitch distance Tp is less or equal to the radius R₀ times five divided by four.

The track pitch in this case is even closer to the radius R₀ of the focused spot which results in the writing region irradiated with a sufficient optical dose comprising the section of the track or groove to be writing and getting even closer to the adjacent tracks or grooves.

By reducing the track pitch more tracks fit on the record carrier allowing more data to be recorded on the same record carrier resulting in an increased data density.

A further embodiment of the method is characterized in that the track pitch distance Tp is less or equal to the radius R₀ times six divided by five.

The track pitch in this case is even closer to the radius R₀ of the focused spot which results in the writing region irradiated with a sufficient optical dose comprising the section of the track or groove to be writing and getting even closer to the adjacent tracks or grooves.

By reducing the track pitch more tracks fit on the record carrier allowing more data to be recorded on the same record carrier resulting in an increased data density.

A further embodiment of the method is characterized in that the sections of the grooves are isolated sections surrounded by land.

By surrounding sections of the grooves with land, essentially creating pits the section of the groove is not only delimited from the adjacent grooves but also from the adjacent sections of the same groove. This allows a better definition of the size of the marks written in the sections of the groove, which in turn allows a reduced distance between the marks, which in turn results in a higher data density.

A further embodiment of the method is characterized in that the dye has an absorption which increases with increasing absorbed optical energy.

The section of the focused spot inside the radius R₀, the inner section of the focused spot, irradiates the record carrier with an optical energy greater or equal to the 1/e times the maximum energy of the optical focused spot, the remaining section of the focused spot outside the radius Ro, the outer section of the focused spot, irradiates the record carrier with an optical energy less than 1/e times the maximum energy of the focused spot. Thus when a dye is used where the absorption increases with increasing absorbed optical energy, the section of the groove irradiated by the inner section of the focused spot will receive a larger dose of optical energy then sections of the groove or sections of the adjacent grooves that are irradiated by the outer section of the focused spot.

As a result of the irradiation, the rate of absorption of the optical energy by the record carrier in the inner section of the focused spot will increase, leading to more absorbed optical energy, leading to an even higher rate of absorption of the optical energy.

In the outer section the optical energy is lower than in the inner section.

Consequently the increase of the rate of absorption is smaller leading to less absorbed optical energy, leading to a smaller increase of the rate of absorption of the optical energy.

The dye in effect amplifies the effect of the irradiation by the focused spot.

Thus, the absorption is more localized resulting in marks recorded on the record carrier of a smaller size and a smaller groove distance compared to when no such dye is used. A higher data density can thus be obtained.

A further embodiment of the method is characterized in that the dye has a threshold for thermal decomposition or degradation and that the threshold is reached between the center of the focused spot and a point in the focused spot where the optical energy is equal or more than 1/e times the maximum optical energy of the focused spot.

Since the distribution of optical energy is not uniform across the focused spot a dye with a threshold will ensure that only in a small section of the focused spot a mark is recorded on the record carrier. In the outer section of the focused spot the optical energy is insufficient to reach the threshold and hence a mark is not recorded on the record carrier. The threshold ensures that a well defined mark is recorded since the distribution of the optical energy across the focused spot is often quite gradual.

Consequently only the inner section of the focused spot is used to record a mark, which is smaller than when the entire focused spot, inner section and outer section, contributes to the recording of the mark.

A further embodiment of the method is characterized in that the land is covered by a layer of the dye with a thickness at least 3 times thinner than a depth of the groove.

When the groove is much deeper than the thickness of the layer of dye on the land, more energy is absorbed by the dye in the groove then the dye on the land, resulting in a mark that is essentially limited in size by the groove, or in the case of pits, by the size of the pits. When the dye further has a threshold or has an absorption which increases with increasing absorbed optical energy, the mark is even more restricted to the groove or pit. Because there is more dye in the groove more optical energy is absorbed by the dye in the groove then by the dye on the land, leading to the described amplification effect. This embodiment ensures that the marks are restricted to the area where most of the energy is absorbed, i.e. restricts the width of the mark to the width of the groove or in case of pits to the size of the pits. This allows the groove pitch, track pitch and the pit size to be reduced since no longer the size of the focused spot determines the size of the mark but the width of the groove and, in case of pits, the size of the pits.

A further embodiment of the method is characterized in that the dye in the groove is thermally insulated from a reflection layer

Since the absorption of the optical energy results in a local increase of temperature in the dye, and as a result of that temperature increase to the formation of the mark, the increase of temperature must be restricted to the area irradiated by the inner section of the focused spot to prevent an increase in temperature outside that region to prevent the formation of a mark outside that region. By thermally insulating the dye from its surroundings the spread heat and the consecutive temperature rise is prevented.

This can be achieved for instance by increasing the distance between the dye and a metallic reflection layer that might conduct the absorbed optical energy thermally to the surrounding area. This embodiment ensures that the marks are restricted to the area where the energy is absorbed, i.e. restricts the width of the mark to the width of the groove or in case of pits to the size of the pits. This allows the groove pitch and the pit size to be reduced since it is no longer the size of the focused spot that determines the size of the mark but the width of the groove and, in case of pits, the size of the pits.

By manufacturing a record carrier that insulates the dye from the reflection layer the use of a smaller groove pitch or pit size is possible, leading to a record carrier with a higher data density. Thermal insulation is achieved by a thin interface barrier, for example a dielectric layer such as ZnS—SiO2, SiO2, SiC or other types of inorganic layers or a thin organic layer. Also Deep grooves will prevent heat leakage to the metallic mirror. Alternatively a non-metallic mirror can be used.

An optical disc according to the invention is characterized in that the track pitch distance Tp is less or equal to the radius R₀ times five divided by three.

The track pitch in this case is close to the radius R₀ of the focused spot which results in the writing region irradiated with a sufficient optical dose comprising the section of the track or groove to be written and getting close to the adjacent tracks or grooves. By reducing the track pitch more tracks fit on the record carrier allowing more data to be recorded on the same record carrier resulting in an increased data density.

An embodiment of the optical disc is characterized in that the track pitch distance Tp is less or equal to the radius R₀ times five divided by four.

The track pitch in this case is even closer to the radius R₀ of the focused spot which results in the writing region irradiated with a sufficient optical dose comprising the section of the track or groove to be writing and getting even closer to the adjacent tracks or grooves.

By reducing the track pitch more tracks fit on the record carrier allowing more data to be recorded on the same record carrier resulting in an increased data density.

An embodiment of the optical disc is characterized in that the track pitch distance Tp is less or equal to the radius R₀ times six divided by five.

The track pitch in this case is even closer close to the radius R₀ of the focused spot which results in the writing region irradiated with a sufficient optical dose comprising the section of the track or groove to be writing and getting even closer to the adjacent tracks or grooves.

By reducing the track pitch more tracks fit on the record carrier allowing more data to be recorded on the same record carrier resulting in an increased data density.

An embodiment of the optical disc is characterized in that the sections of the grooves are pits. Pits can be regarded as isolated sections of the groove surrounded by land on all sides.

By surrounding sections of the grooves with land, essentially creating pits, the section of the groove is not only delimited from the adjacent grooves but also from the adjacent sections of the same groove. This allows a better definition of the size of the marks written in the sections of the groove, which in turn allows a reduced distance between the marks, which in turn results in a higher data density.

An embodiment of the optical disc is characterized in that the dye has an absorption which increases with increasing absorbed optical energy.

The section of the focused spot inside the radius Ro, the inner section of the focused spot, irradiates the record carrier with an optical energy greater or equal to the 1/e times the maximum energy of the optical focused spot, the remaining section of the focused spot outside the radius Ro, the outer section of the focused spot, irradiates the record carrier with an optical energy less than 1/e times the maximum energy of the focused spot. Thus when a dye is used where the absorption increases with increasing absorbed optical energy, the section of the groove irradiated by the inner section of the focused spot will receive a larger dose of optical energy then sections of the groove or sections of the adjacent grooves that are irradiated by the outer section of the focused spot.

As a result of the irradiation, the rate of absorption of the optical energy by the record carrier in the inner section of the focused spot will increase, leading to more absorbed optical energy, leading to an even higher rate of absorption of the optical energy.

In the outer section the optical energy is lower than in the inner section.

Consequently the increase of the rate of absorption is smaller leading to less absorbed optical energy, leading to a smaller increase of the rate of absorption of the optical energy.

The dye in effect amplifies the effect of the irradiation by the focused spot.

Thus, the absorption is more localized resulting in marks recorded on the record carrier of a smaller size and a smaller groove distance compared to when no such dye is used. A higher data density can thus be obtained.

An embodiment of the optical disc is characterized in that the dye has a threshold for thermal decomposition or degradation and that the threshold is reached between the center of the focused spot and a point in the focused spot where the optical energy is equal or more than 1/e times the maximum optical energy of the focused spot.

Since the distribution of optical energy is not uniform across the focused spot a dye with a threshold will ensure that only in a small section of the focused spot a mark is recorded on the record carrier. In the outer section of the focused spot the optical energy is insufficient to reach the threshold and hence a mark is not recorded on the record carrier.

The threshold ensures that a well defined mark is recorded since the distribution of the optical energy across the focused spot is often quite gradual.

Consequently only the inner section of the focused spot is used to record a mark, which is smaller than when the entire focused spot, inner section and outer section, contributes to the recording of the mark.

An embodiment of the optical disc is characterized in that the land is covered by a layer of the dye with a thickness at least 3 times thinner than a depth of the groove.

When the groove is much deeper than the thickness of the layer of dye on the land, more energy is absorbed by the dye in the groove then the dye on the land, resulting in a mark that is essentially limited in size by the groove, or in the case of pits, by the size of the pits. When the dye further has a threshold or has an absorption which increases with increasing absorbed optical energy, the mark is even more restricted to the groove or pit. Because there is more dye in the groove more optical energy is absorbed by the dye in the groove then by the dye on the land, leading to the described amplification effect. This embodiment ensures that the marks are restricted to the area where most of the energy is absorbed, i.e. restricts the width of the mark to the width of the groove or in case of pits to the size of the pits. This allows the groove pitch, track pitch and the pit size to be reduced since no longer the size of the focused spot determines the size of the mark but the width of the groove and, in case of pits, the size of the pits.

An embodiment of the optical disc is characterized in that the dye in the groove is thermally insulated from a reflection layer.

Since the absorption of the optical energy results in a local increase of temperature in the dye, and as a result of that temperature increase to the formation of the mark, the increase of temperature must be restricted to the area irradiated by the inner section of the focused spot to prevent an increase in temperature outside that region to prevent the formation of a mark outside that region. By thermally insulating the dye from its surroundings the spread of increase of temperature is prevented.

This can be achieved for instance by increasing the distance between the dye and a metallic reflection layer that might conduct the absorbed optical energy thermally to the surrounding area. This embodiment ensures that the marks are restricted to the area where the energy is absorbed, i.e. restricts the width of the mark to the width of the groove or in case of pits to the size of the pits. This allows the groove pitch and the pit size to be reduced since no longer the size of the focused spot determines the size of the mark but the width of the groove and, I case of pits, the size of the pits.

By manufacturing a record carrier that insulates the dye from the reflection layer the use of a smaller groove pitch or pit size is possible, leading to a record carrier with a higher data density.

A recorder according to the invention is characterized in that the radius R₀ is greater than or equal to the track pitch Tp times three divided by five.

The radius R₀ of the focused spot is slightly larger than the track pitch, which results in the writing region irradiated with a sufficient optical dose comprising the section of the track or groove to be written and getting close to the adjacent tracks or grooves. For a given value of the radius R₀ the track pitch can be reduced so that the focused spot gets closer to the adjacent grooves.

By reducing the track pitch more tracks fit on the record carrier allowing more data to be recorded on the same record carrier resulting in an increased data density.

An embodiment of the recorder according to the invention is characterized in that the radius R₀ is greater than or equal to the track pitch Tp times four divided by five.

For a given value of the radius R₀ the track pitch can be reduced so that the focused spot gets closer to the adjacent grooves or even starts to cover sections of the adjacent grooves

The track pitch is thus further reduced compared to the radius R₀ of the focused spot, which results in more tracks fitting on the record carrier, allowing more data to be recorded on the same record carrier resulting in an increased data density.

A recorder according to the invention is characterized in that the radius R₀ is greater than or equal to the track pitch Tp times five divided by six.

For a given value of the radius R₀ the track pitch can be further reduced so that the focused spot gets even closer to the adjacent grooves or even starts to cover sections of the adjacent grooves

The track pitch is thus yet further reduced compared to the radius R₀ of the focused spot, which results in even more tracks fitting on the record carrier, allowing even more data to be recorded on the same record carrier resulting in an increased data density.

The above description is based on temperature induced degradation, decomposition or alteration of the dye but photo induced degradation, decomposition or alteration of the dye can equally be applied.

The invention will now be described in figures.

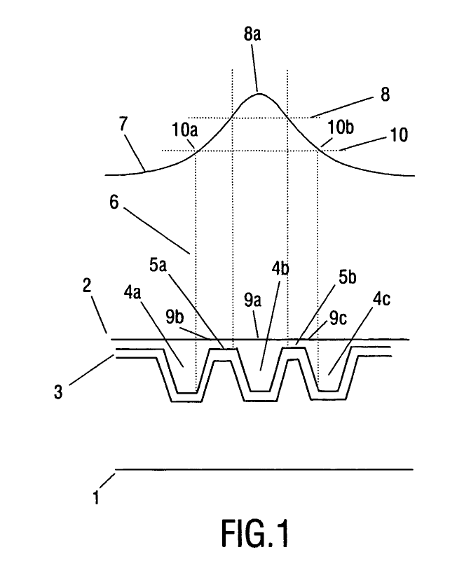

FIG. 1 shows a cross section of a recording medium with grooves.

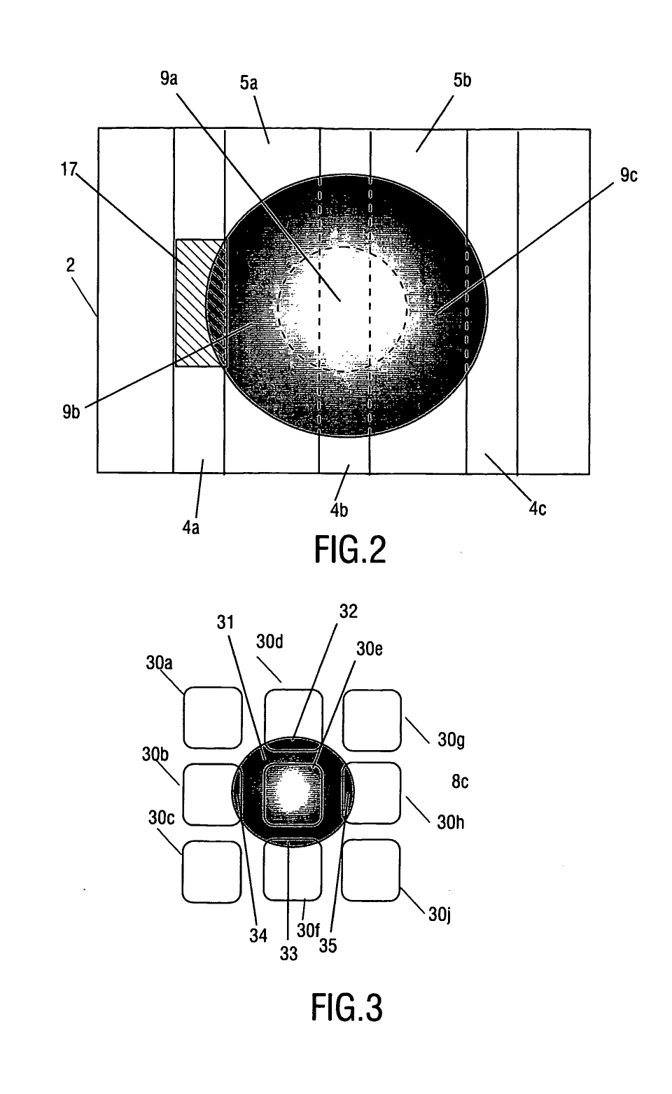

FIG. 2 shows the radiation area on a recording medium with grooves

FIG. 3 shows the radiation on a recording medium with pits

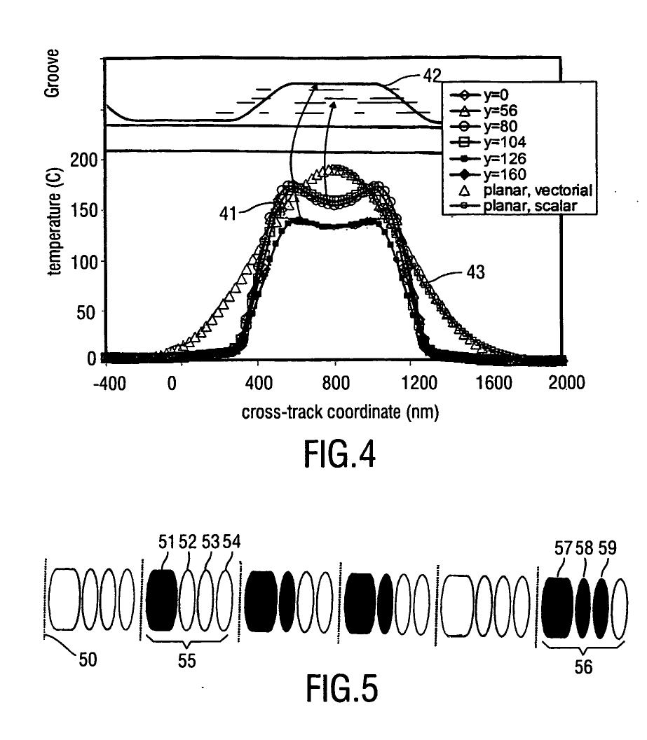

FIG. 4 shows the temperature profile in a groove resulting from the irradiation.

FIG. 5 shows a pit structure for multi level recording.

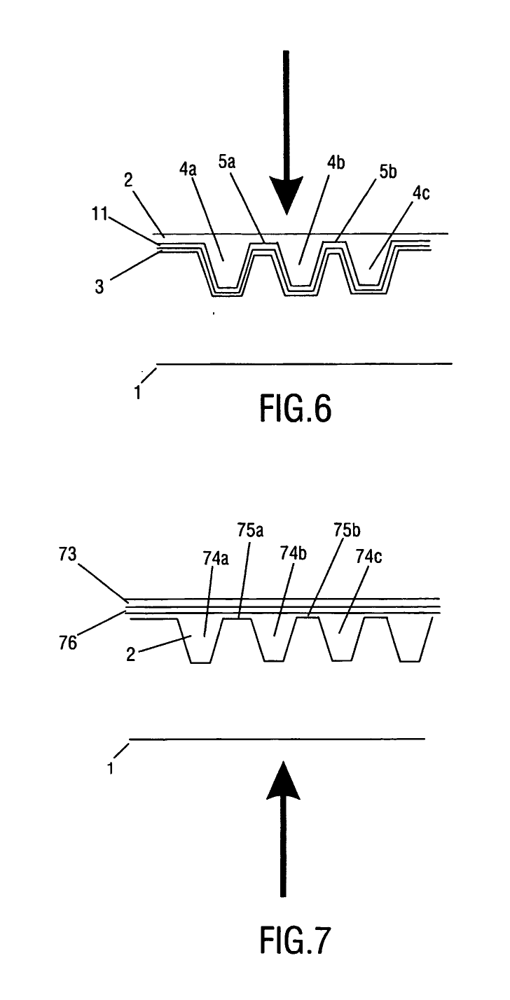

FIG. 6 shows a recording stack

FIG. 7 shows an alternative recording stack

FIG. 1 shows a cross section of a recording medium with grooves. The record carrier 1 comprises a dye layer 2, a reflective layer 3 and a groove 4a, 4b, 4c. To explain the recording of information three grooves 4a, 4b, 4c and two lands 5a, 5b, separating the grooves, are shown. When recording information in the central groove 4b to form marks on the record carrier 1 the dye layer in the central groove 4b is irradiated by a laser that applies a dose 7 of optical energy.

The laser beam has a dose 7 with a non-uniform distribution of optical energy across the beam. This dose 7 with a nonuniform distribution is shown in FIG. 1 as a bell curve but may differ for various optical recording systems. Another example of a non uniform distribution across the beam, and consequently also non uniform distribution across the focused spot on the disc, is the airy pattern. The central section 9a of the focused spot where the dose 7 exceeds a first level 8 is aligned with the central groove 4b. The first level 8 is the critical level for mark formation.

As can be seen in FIG. 1 the non-uniform distribution of the dose 7 results in a dose exceeding the first level 8 being applied to the middle groove 4b in the central section 9a, but also to the two lands 5a, 5b next to the central groove 4b.

The left groove 4a and the right groove 4c receive a dose of optical energy below the first level 8

On a regular recording medium the track pitch, i.e. the distance between the centers of the tracks 4a, 4b, 4c has to be chosen such that the dose 7 of optical energy received by the left groove 4a and the right groove 4c or the lands 5a, 5b does not exceed a first level 8 where the formation of a mark would occur.

When the central groove 4b of the recording medium is irradiated with a dose of optical energy exceeding the first level 8 a mark is formed in the groove 4b in the central section 9a of the focused spot. Because of the groove 4b the formation of the mark will occur rapidly since the optical energy absorbed by the thick layer of dye 2 in the groove 4b will alter the characteristics of the dye 2. More dye material will absorb more of the optical dose 7, thus contributing to the rapid formation of the mark. On the lands 5a, 5b the outer sections 9c, 9d of the focused spot irradiate a thinner layer of dye. The thinner layer of dye on the lands 5a, 5b will absorb less of the dose 7 of optical energy. The formation of the mark on the lands 5a, 5b will thus be slower than in the central groove 4b. Also the left groove 4a and the right groove 4c will receive a dose of optical energy. The absorption by the thicker dye in those grooves 4a, 4c will be higher compared to the lands 5a, 5b but a dose below the first level 8, i.e. a dose which is lower than the dose applied to the central groove 4b, is applied. The formation of the mark will thus be slower in the left groove 4a and the right groove 4c than in the central groove 4b where a higher dose of optical energy is applied. The critical dose for altering the dye and consequently recording a mark is not reached in the left groove 4a and the right groove 4c.

By controlling the dose of optical energy and the duration of the irradiation a mark that is mainly limited in width to the width of the central groove 4b can be recorded. Because of the groove structure and the resulting differences in absorption by the dye in the grooves and on the lands the track pitch of the grooves can be reduced allowing a higher data density.

A first dose 10a and a second dose 10b correspond to the transition from the inner section 9a of the beam to the outer section 9b, 9c of the focused spot and correspond approximately to a dose of optical energy which is 1/e times the maximum dose 8a.

When a dye 2 is used where the absorption increases with increasing absorbed dose of optical energy, the section of the central groove 4b irradiated by the central section 9a of the focused spot will absorb a dose exceeding the first level 8 while the sections of the adjacent grooves 4a, 4c that are irradiated by the outer section 9b, 9c of the focused spot.

As a result of the irradiation, the rate of absorption of the optical energy by the dye 2 in the central groove 4b will increase, leading to an increased amount of absorbed optical energy, leading to even higher rate of absorption of optical energy.

In the left groove 4a and the right groove 4c the dose of optical energy is lower.

Consequently the increase of the rate of absorption is smaller leading to less absorbed optical energy, leading to a smaller increase of the rate of absorption of the optical energy. The total absorbed dose of optical energy is thus lower for the left groove 4a and the right groove 4c when compared to the central groove 4b. A mark is thus more rapidly formed in the central groove 4b.

The dye 2 in effect amplifies the non-uniform distribution of the optical energy across the focused spot.

Thus, the absorption is limited to a section of the central groove 4b resulting in marks recorded on the record carrier of a smaller size and a smaller groove distance compared to when no such dye which increases the rate of absorption with increased absorbed optical energy is used. A higher data density can thus be obtained.

FIG. 2 shows the radiation area on a recording medium with grooves The beam projects a dose of optical energy in an focused spot 9a, 9b, 9c on the record carrier 1. The focused spot 9a, 9b, 9c receiving a dose is indicated by an gray shaded oval. The focused spot 9a, 9b, 9c shows that the focused spot 9a, 9b, 9c that receives a dose of optical energy is not only limited in a radial direction, i.e. perpendicular to the reading direction of the grooves 4a, 4b, 4c but is also limited in the reading direction, i.e. the tangential direction, of the central groove 4b.

The outer sections 9b, 9c of the focused spot 9a, 9b, 9c irradiate the lands 5a, 5b.

The center region 9a of the focused spot is aligned with the central groove 4b.

The figure shows a circular focused spot but other shapes can be used as well.

An observed characteristic of some dyes is that after writing a mark an irradiation with a lower dose result in a shrinkage of the previously recorded mark. The present invention can be used advantageously to obtain this effect since the focused spot overlaps with adjacent grooves 4a, 4c and, when irradiating the central groove 4b, irradiates the adjacent grooves 4a, 4c with a lower dose. In FIG. 2 the areas 9b, 9c of the adjacent grooves 4a, 4c that would receive such a lower dose are indicated.

In a first recording pass a first mark 17 with a first size can be recorded in for instance the first groove 4a When recording a mark in the second groove 4b the size of the first mark 17 is reduced. Thus smaller marks can be obtained allowing an even higher data density to be achieved. Using 2D-read-out methods such small marks can still be read reliably. In a 2 dimensional readout mode, light reflected by the data present in the adjacent data tracks, is indeed detected in the central aperture signal.

When using pits, synchronization of pits is very important since the pits in the adjacent tracks need to be placed with high spatial accuracy with respect to pits in the central track. By aligning the pits and marks spatially to each other a 2 dimensional grid is obtained where 2 dimensional read-out can be used advantageously.

When using pits, synchronization of pits is very important since the pits in the adjacent tracks need to be placed with high spatial accuracy with respect to pits in the central track. Two options exist to solve this problem:

1. Pre-mastered lands or spikes for synchronization.

2. Written long (e.g. 120) pits/marks that enable the reconstruction of the synchronization pattern. Synchronization is done by measuring the long syncs in the adjacent track via optical cross talk. Since the track pitch is much smaller than the optical spot size (diffraction limit), it is expected that the adjacent marks will be detected when focusing on the central track.

FIG. 3 shows the radiation area on a recording medium with pits When a record carrier with pits 30a, 30b, 30c, 30d, 30e, 30f, 30g, 30h, 30j is used, i.e. sections of the grooves 4a, 4b, 4c are separated by lands, the formation of the mark is also limited by the pits. Instead of two sides of the mark being defined by the groove, the mark is defined by all four sides of the pit.

The focused spot with a non-uniform distribution of the dose of optical energy is aligned with a first pit 30e, surrounded by neighboring pits 30a, 30b, 30c, 30d, 30f, 30g, 30h, 30j. Because the region 31 irradiated by the focused spot is larger than the first pit 30e, the region 31 also overlaps land area between the pits 30a, 30b, 30c, 30d, 30e, 30f, 30g, 30h, 30j and even sections 32, 33, 34, 35 of neighboring pits 30b, 30d, 30f, 30h.

Because the dose of optical energy received by the sections 31, 32, 33, 34 of neighboring pits 30b, 30d, 30f, 30h is lower than the dose of energy received by the first pit 30e, the rate of absorption increases more rapidly in the first pit than in the sections 32, 33, 34, 35 of neighboring pits 30b, 30d, 30f, 30h.

This results in the formation of the mark being limited to the first pit 30e.

Because of the pit the formation of the mark will occur rapidly since the optical energy absorbed by the thick layer of dye in the pit will alter the characteristics of the dye. More dye material will absorb more of the optical dose, thus contributing to the rapid formation of the mark. The land between the pits is covered by a thinner layer of dye. The thinner layer of dye on the land will absorb less of the dose of optical energy. The formation of the mark on the land around the first pit 30e will thus be slower than in the pit 30e. Also surrounding pits 30b, 30d, 30f, 30h will receive a dose of optical energy. The absorption by the thicker dye in those surrounding pits 30b, 30d, 30f, 30h will be higher compared to the land but a lower dose is applied than to the land. The formation of the mark will thus be slower in the surrounding pits 30b, 30d, 30f, 30h than in the first pit 30e where a higher dose of optical energy is applied. The critical dose for altering the dye, the first level 8 as indicated in FIG. 1, is not reached in the surrounding pits 30b, 30d, 30f, 30h.

By controlling the dose of optical energy and the duration of the irradiation a mark that is mainly limited in width and length to the pit can be formed.

Because of the pit structure and the resulting differences in absorption by the dye in the grooves and on the lands the track pitch of the grooves can be reduced allowing a higher data density.

An observed characteristic of some dyes is that after writing a mark an irradiation with a lower dose result in a shrinkage of the previously recorded mark. The present invention can be used advantageously to obtain this effect since the focused spot overlaps with adjacent pits 30b, 30d, 30f, 30h in overlap areas 32, 33, 34, 35 and, when irradiating the central pit 30e, irradiates the adjacent overlap areas 32, 33, 34, 35 with a lower dose. In a first recording pass a first mark with a first size can be recorded in for instance a first pit 30b. When recording a mark in the adjacent pit 30e the size of the first mark in the first pit 30b is reduced. Thus smaller marks, even more confined to the pits can be obtained allowing an even higher data density to be achieved. This effect can also be used advantageously to obtain pit shrinkage for the other adjacent pits 30d, 30f, 30h where the focused spot overlaps a previously recorded mark.

FIG. 4 shows the temperature distribution in a groove resulting from the irradiation.

The track pitch is much smaller than the diffraction limited optical spot, which is possible because of the super-resolution technique we propose for writing the data. The pre-grooves in the recording medium are chosen small. The pre-grooved substrate is typically covered with a spin-coated dye layer. The dye fills perfectly the grooves but almost no dye layer is present at the intermediate lands. If the optical spot is focused on a groove, absorption mainly occurs in the grooves, leading to a very localized temperature rise.

In FIG. 4 cross-sectional temperature distributions 40, 41 are shown that are calculated for a write-once recording stack at CD-R conditions. The pre-groove structure 42 is also indicated in the figure. Shown are typical cross-sectional temperature profiles 40, 41 in case of groove absorption. The groove is filled with dye material while the lands are only covered with a very thin layer of dye. A ratio of 1:3 or higher between dye layer thickness on the land and in the groove is adequate. Further, a reference curve 43 is calculated for the situation that no grooves are present in the substrate, i.e. a planar dye layer. It is clearly seen that the temperature in the groove rises more sharply then outside the groove, i.e. the temperature rise is mainly limited to the groove.

Since it is the temperature that alters the dye to form a mark the formation of the mark is also mainly limited to the groove 42. By selecting a dye where the absorption increases with increased temperature of the dye, resulting from a previously absorbed dose of optical energy, the localization of the mark can further be enhanced.

In this way super-resolution can be achieved with narrow grooves.

The temperature rise is further localized due to the low thermal conductivity of the organic materials applied in the storage medium. A second effect is the threshold behavior of typical dyes. Only if a certain temperature is exceeded, the dye material starts to deteriorate (bleach or decompose). Another effect making this threshold effect stronger is the temperature-dependent absorption of the recording dye. These effects cause that mainly the central part of the optical (and thermal) spot cause the formation of a pit. If the data track-pitch is significantly reduced, for example 180 nm in case of Blu-ray Disc conditions, marks can be written in the central track without substantial deterioration of the data in the adjacent tracks. It is however noted that some pit-shrinkage effects may occur but this can be compensated for in a dedicated calibration routine.

In a 2 dimensional readout mode, light reflected by the data present in the adjacent data tracks, is indeed detected in the central aperture signal. By aligning the pits and marks spatially to each other a 2 dimensional grid is obtained where 2-dimensional read-out can be used advantageously.

FIG. 5 shows a pit structure for multi level recording

A track 50 comprises multiple pits 51, 52, 53, 54, 55, 56, 57, 58, 59. A group of pits 51, 52, 53, 54 forms a unity cell 55. This allows multilevel recording. By irradiating one or more of the pits 51, 52, 53, 54 of the unity cell 55 the unity cell 55 can represent an multi level signal. The first pit 51 of the unity cell 55 can be of a different size than the other pits 52, 53, 54 of the unity cell 55. This allows the start of the unity cell 55 to be determined. In the first unity cell 55 shown only the first pit 51 is irradiated to form a mark. In the second unity cell 56 the first three pits 57, 58, 59 are irradiated to form a mark. When using the present invention the marks recorded on the record carrier are defined by the size of the preformed pits which allows the small marks for multilevel recording to be written because for multilevel recording the levels must be well defined in order to obtain a sufficient signal to noise ratio when reading the data from the record carrier.

FIG. 6 shows a recording stack

The stack is identical to the one shown in FIG. 1.

The record carrier 1 comprises a reflective layer 3, preferably having low thermal conductivity in order to restrict the temperature rise in the groove or pit to the groove or pit without conducting heat to adjacent grooves or pits. The reflective layer 3 covers the grooves 4a, 4b, 4c (or pits) and lands 5a, 5b. The reflective layer 3 is covered by a dye 2 which fills the grooves 4 but is thin on the lands 5. This stack is irradiated in the direction indicated by the arrow. An interface layer 11 can be added between the dye 2 and the reflective layer 3 to provide thermal insulation if the reflective layer 3 does conduct heat. This interface layer 11 can be an organic or anorganic layer which does not absorb optical energy and does not conduct heat very well.

FIG. 7 shows an alternative recording stack

The record carrier 1 comprises a reflective layer 73, preferably having low thermal conductivity in order to restrict the temperature rise in the groove or pit to the groove or pit without conducting heat to adjacent grooves or pits. The reflective layer 73 covers the dye 72. which in turn fills the grooves 74a, 74b, 74c (or pits) and forms a thin layer on the lands 75a, 75b. This stack is irradiated in the direction indicated by the arrow.

An interface layer 76 can be added between the dye 2 and the reflective layer 73 to provide thermal insulation if the reflective layer 3 does conduct heat. This interface layer 76 can be an organic or anorganic layer which does not absorb optical energy and does not conduct heat very well.

1. Method of recording information on an optical disc comprising a first groove, a second groove adjacent to the first groove and a land separating the first groove from the second groove by a track pitch distance Tp where the grooves are filled with a dye, where the land is covered by the dye, the method comprising irradiating a region of the optical disc with a focused spot of optical energy having a radius R₀ between a center of the focused spot and a point in the focused spot where the optical energy 1/e times a maximum optical energy of the focused spot,
characterized in that the track pitch distance Tp is less or equal to the radius R₀ times five divided by three.

2. Method as claimed in claim 1,
characterized in that the track pitch distance Tp is less or equal to the radius R₀ times five divided by four.

3. Method as claimed in claim 1,
characterized in that the track pitch distance Tp is less or equal to the radius R₀ times six divided by five.

4. Method as claimed in claim 1,
characterized in that the track pitch is less or equal to R₀

5. Method as claimed in claim 1,
characterized in that the sections of the grooves are pits.

6. Method as claimed in claim 1,
characterized in that the dye has an absorption which increases with increasing absorbed optical energy.

7. Method as claimed in claim 1,
characterized in that the dye has a threshold for thermal decomposition or degradation and that the threshold is reached between the center of the focused spot and a point in the focused spot where the optical energy is equal or more than 1/e times the maximum optical energy of the focused spot.

8. Method as claimed in claim 1,
characterized in that
the land is covered by a layer of the dye with a thickness at least 3 times thinner than a depth of the groove.

9. Method as claimed in claim 6,
characterized in that the dye in the groove is thermally insulated from a reflection layer

10. Method as claimed in claim 1,
characterized in that adjacent marks are spatially aligned to each other.

11. Method as claimed in claim 5,
characterized in that adjacent pits are spatially aligned to each other.

12. Optical disc comprising a first groove, a second groove adjacent to the first groove and a land separating the first groove from the second groove by a track pitch distance Tp where the grooves are filled with a dye, where the land is covered by the dye, for irradiation of the optical disc with a focused spot of optical energy having a radius R₀ between a center of the focused spot and a point in the focused spot where the optical energy 1/e times a maximum optical energy of the focused spot, characterized in that the track pitch distance Tp is less or equal to the radius R₀ times five divided by three.

13. Optical disc as claimed in claim 12,
characterized in that the track pitch distance Tp is less or equal to the radius R₀ times five divided by four.

14. Optical disc as claimed in claim 12,
characterized in that the track pitch distance Tp is less or equal to the radius R₀ times six divided by five.

15. Optical disc as claimed in claim 12,
characterized in that the sections of the grooves are pits.

16. Optical disc as claimed in claim 12,
characterized in that the dye has an absorption which increases with increasing absorbed optical energy.

17. Optical disc as claimed in claim 12,
characterized in that the dye has a threshold for thermal decomposition or degradation and that the threshold is reached between the center of the focused spot and a point in the focused spot where the optical energy is equal or more than 1/e times the maximum optical energy of the focused spot.

18. Optical disc as claimed in claim 12,
characterized in that
the land is covered by a layer of the dye with a thickness at least 3 times thinner than a depth of the groove.

19. Optical disc as claimed in claim 16,
characterized in that the dye in the groove is thermally insulated from a reflection layer

20. Optical disc as claimed in claim 12,
characterized in that adjacent marks are spatially aligned to each other.

21. Optical disc as claimed in claim 15,
characterized in that adjacent pits are spatially aligned to each other.

22. Recorder for recording optical discs comprising means for recording information on an optical disc comprising a first groove, a second groove adjacent to the first groove and a land separating the first groove from the second groove by a track pitch distance Tp where the grooves are filled with a dye, where the land is covered by the dye, the recorder comprising irradiation means for projecting a focused spot of optical energy having a radius R₀ between a center of the focused spot and a point in the focused spot where the optical energy 1/e times a maximum optical energy of the focused spot on the optical disc, characterized in that the radius R₀ is greater than or equal to the track pitch Tp times three divided by five.

23. Recorder for recording optical discs comprising means for recording information on an optical disc comprising a first groove, a second groove adjacent to the first groove and a land separating the first groove from the second groove by a track pitch distance Tp where the grooves are filled with a dye, where the land is covered by the dye, the recorder comprising irradiation means for projecting a focused spot of optical energy having a radius R₀ between a center of the focused spot and a point in the focused spot where the optical energy 1/e times a maximum optical energy of the focused spot on the optical disc, characterized in that the radius R₀ is greater than or equal to the track pitch Tp times four divided by five.

24. Recorder for recording optical discs comprising means for recording information on an optical disc comprising a first groove, a second groove adjacent to the first groove and a land separating the first groove from the second groove by a track pitch distance Tp where the grooves are filled with a dye, where the land is covered by the dye, the recorder comprising irradiation means for projecting a focused spot of optical energy having a radius R₀ between a center of the focused spot and a point in the focused spot where the optical energy 1/e times a maximum optical energy of the focused spot on the optical disc, characterized in that the radius R₀ is greater than or equal to the track pitch Tp times five divided by six.
